(19) United States
(12) Patent Application Publication
(10) Pub. No.: US 2020/0386080 A1
(43) Pub. Date: Dec. 10, 2020

(54) Fracturing-Fluid Formula Workflow

(71) Applicant: Saudi Arabian Oil Company, Dhahran (SA)

(72) Inventors: Chicheng Xu, Houston, TX (US); Leiming Li, Sugar Land, TX (US); Yanhui Han, Katy, TX (US)

(21) Appl. No.: 16/433,735

(22) Filed: Jun. 6, 2019

(51) Int. Cl. E21B 41/00; E21B 43/26; G06F 17/50

(52) U.S. Cl. CPC E21B 41/0092; G06F 2217/16; G06F 17/5009; E21B 43/26

(57) ABSTRACT

A system and method for specifying a composition for a frac fluid including varying crosslinker concentration and high-temperature stabilizer concentration to determine a discrete fracture network (DFN) and hydrocarbon production correlative with the DFN.

### TECHNICAL FIELD

This disclosure relates to formulating a fracturing fluid for hydraulic fracturing.

### BACKGROUND

Hydraulic fracturing employs fluid and material to generate fractures in a geological formation in order to stimulate production from oil and gas wells. Hydraulic fracturing is a well-stimulation technique in which rock is fractured by a pressurized liquid that be a fracturing fluid (frac fluid). The process can involve the pressure injection of frac fluid into a wellbore to generate cracks in the deep-rock formations through which natural gas, petroleum, and brine will flow more freely. The fracturing typically generates paths that increase the rate at which production fluids can be produced from the reservoir formations. The production fluids can be oil and natural gas. The amount of increased production may be related to the amount of fracturing. Hydraulic fracturing may allow for the recovery of oil and natural gas from unconventional formations that geologists once believed were impossible to produce.

### SUMMARY

An aspect relates to a method of specifying a composition for a frac fluid. The method includes varying a crosslinker concentration in the frac fluid, varying a high-temperature stabilizer concentration in the frac fluid, and determining viscosity of the frac fluid. The method includes determining a discrete fracture network (DFN) correlative with the viscosity. The method includes determining hydrocarbon production correlative with the DFN by employing a geomechanical model and a reservoir model.

Another aspect relates to a method of determining a composition for a frac fluid. The method includes determining viscosity for the frac fluid. The viscosity is affected by a crosslinker concentration for the frac fluid and a high-temperature stabilizer concentration for the frac fluid. The method includes employing a hydraulic fracture model to simulate hydraulic fracturing of a geological formation with the frac fluid. An output of the hydraulic fracture model is a DFN. The method includes employing a geomechanical model and a reservoir model to give hydrocarbon production from the geological formation based on the DFN. The method includes determining a financial gain correlative with the crosslinker concentration, the high-temperature stabilizer concentration, and the hydrocarbon production. The method includes adjusting the crosslinker concentration for the frac fluid and the high-temperature stabilizer concentration for the frac fluid to increase the financial gain.

Yet another aspect is a method of determining or specifying a composition for a frac fluid and with the method specifying a crosslinker concentration for the frac fluid and a stabilizer concentration for the frac fluid. The method includes determining viscosity of the frac fluid having the crosslinker concentration as specified and the stabilizer concentration as specified. The method includes simulating, via a hydraulic fracture model, hydraulic fracturing of a geological formation with the frac fluid having the viscosity, the crosslinker concentration as specified, and the stabilizer concentration as specified. An output of the simulation is a DFN correlative with the viscosity. The method includes coupling a geomechanical model with a reservoir model to predict hydrocarbon production from the geological formation based on the DFN. The method includes determining a financial gain correlative with the crosslinker concentration, the stabilizer concentration, and the hydrocarbon production. The method includes adjusting the specifying of the crosslinker concentration and the stabilizer concentration to increase the financial gain. In one implementation, the method may include selecting the crosslinker concentration and the stabilizer concentration based on the financial gain.

Yet another aspect is a computing system to specify crosslinker concentration and stabilizer concentration in a frac fluid for hydraulic fracturing. The computing system includes a hydraulic fracture model to receive a value of viscosity of a frac fluid and output a DFN correlative with the value of the viscosity. The computing system includes a geomechanical model and a reservoir model. The geomechanical model and the reservoir model are coupled to give a hydrocarbon production correlative with the DFN. The computing system includes an economic calculator to determine financial gain correlative with the crosslinker concentration, the stabilizer concentration, and the hydrocarbon production.

Yet another aspect is a computing system for hydraulic fracturing. The computing system includes a multi-variable model that correlates viscosity of a frac fluid with a crosslinker concentration of the frac fluid and a high-temperature stabilizer concentration of the frac fluid. The computing system includes a hydraulic fracture model to receive a viscosity value of the viscosity from the multi-variable model, simulate hydraulic fracturing of a geological formation with the frac fluid, and output a DFN correlative with the viscosity. The computing system includes a geomechanical model and a reservoir model coupled to give an amount of hydrocarbon production correlative with the DFN. The computing system includes an adjuster to change the crosslinker concentration in the multi-variable model and the high-temperature stabilizer concentration in the multi-variable model.

Yet another aspect is a hydraulic fracturing system including a pump to inject a frac fluid through a wellbore into a geological formation to hydraulically fracture the geological formation. The frac fluid has a crosslinker and a high temperature stabilizer. The hydraulic fracturing system has a hydraulic fracture model to receive a value of viscosity of the frac fluid and output a DFN correlative with the value of the viscosity. The value of viscosity is correlative with crosslinker concentration in the frac fluid and high-temperature stabilizer concentration in the frac fluid. The hydraulic fracturing system has a geomechanical model and a reservoir model coupled to give a value for hydrocarbon production correlative with the DFN. The hydraulic fracturing system has an economic calculator to determine financial gain correlative with the crosslinker concentration, the stabilizer concentration, and the hydrocarbon production.

The details of one or more implementations are set forth in the accompanying drawings and the description to be presented. Other features and advantages will be apparent from the description and drawings, and from the claims.

### BRIEF DESCRIPTION OF DRAWINGS

FIG. 1 is a diagram of a well system having a wellbore formed through the Earth surface into a geological formation in the Earth crust.

FIG. 2 is a plot of fluid viscosity and temperature over time.

FIG. 3 is a plot of fluid viscosity and temperature over time.

FIG. 4 is a block flow diagram of a workflow to determine compositions for a hydraulic fracturing fluid to achieve hydrocarbon production from a geological formation at beneficial economic impact.

FIG. 5 is a block diagram of a computing system that determines a composition to specify for a frac fluid.

FIG. 6 is a block flow diagram of component outputs and relationships in operation of the computing system of FIG. 5.

FIG. 7 is a block flow diagram of a method for hydraulic fracturing.

FIG. 8 is a block diagram of computing system having a processor and memory storing code executed by the processor 802.

FIG. 9 is a block diagram depicting a tangible, non-transitory, machine readable medium to facilitate determining, predicting, or specifying frac-fluid composition, frac-fluid viscosity, hydrocarbon production, and associated financial gain.

Like reference numbers and designations in the various drawings indicate like elements.

### DETAILED DESCRIPTION

Some aspects of the present disclosure are directed to a workflow to determine and specify a composition for hydraulic fracturing fluid (frac fluid). The workflow may determine chemical components and their concentration in the frac fluid to give a desired or specified viscosity of the frac fluid. The workflow may employ laboratory work, field effort, and analytical modeling. The analytical modeling may be based on data obtained in the laboratory or field.

Certain rock of geological formations, such as shale, may contain crude oil or natural gas that will not flow freely to a producing well. The hydrocarbons do not flow because the rock either lacks permeability or the pore spaces in the rock are small compared to other formations. These unconventional formations may have a permeability of less than 1 millidarcy. Hydraulic fracturing addresses this problem by generating fractures in the formation rock. In a fracturing job, frac fluid carrying proppant is pumped under pressure into the petroleum-bearing rock to create fractures that are propped open with the proppant. The frac fluids are pumped into the wellbore at specified pumping rates. When the pressure generated by the pumped fracturing fluid exceeds the fracture pressure or fracture stress of the formation rock, the formation rocks break down to form fractures into which fracturing fluids are further injected. Proppant-laden fracturing fluids can increase fracture length and width. Proppant particles are transported into the factures to keep the created fractures open during or following the fracturing treatment.

In low-permeability formations or reservoirs (for example, permeability less than 1 millidarcy), hydraulic fracturing design focuses more on creating fracture length and complexity than conductivity as hydraulic-fracture surface area more influences production. In ultra-low permeability reservoirs such as shale formations (for example, permeability less than 1 microdarcy), hydraulic fracturing is designed to create complexity because the surface area in the network of created complex fractures and natural fractures is larger than that in a simple planar fracture.

Less viscous fluids (for example, having a viscosity less than 100 centipoise (cP)) are utilized as frac fluid to promote fracture complexity and reduce cost. Such a less viscous fluid may have a viscosity, for example, in the range of 0.5 cP to 10 cP. The proppant transport behavior depends on frac fluid properties such as fluid viscosity. Less viscous fluids can limit proppant transport to the fracture tips because proppant can drop out (settle) and form an immovable bed at the bottom of the fracture.

More viscous fluids, such as crosslinked frac fluids, can suspend and carry greater concentrations of proppant. A more viscous fluid may have a viscosity, for example, greater than 100 cP. A typical crosslinked frac fluid is water-based. In addition to water, the frac fluid may contain a gelling agent such as guar or guar derivative, a crosslinker (for example, borate or a zirconium (Zr) crosslinker), a high temperature stabilizer, a biocide, a surfactant, and a buffer. Typical proppants include sand crystals and ceramic beads. Fracturing of conventional oil and gas wells can utilize, for example, 300,000 pounds of proppant per well. Fracturing of shale gas wells can utilize, for example, more than 4 million pounds of proppant per well.

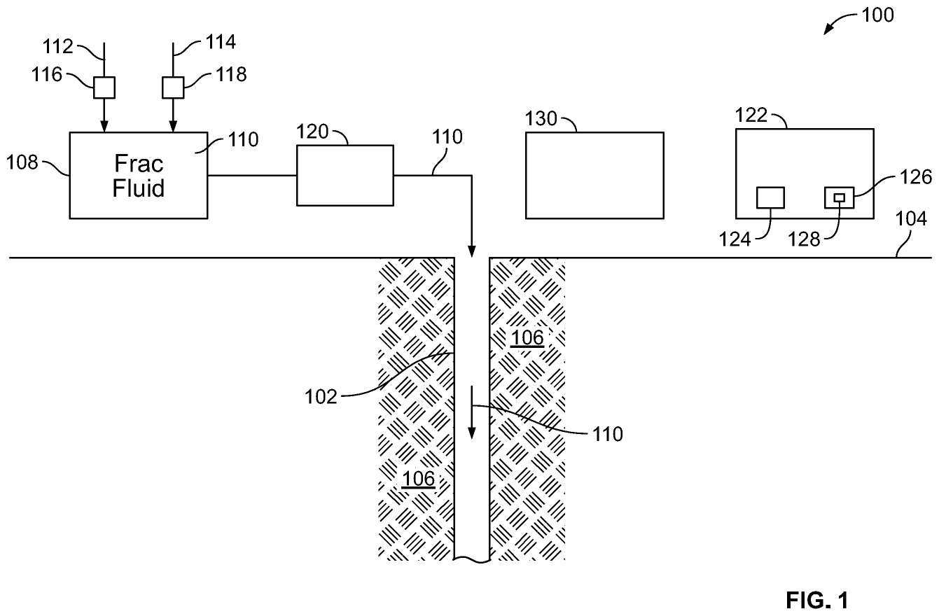

FIG. 1 is a well system 100 having a wellbore 102 formed through the Earth surface 104 into a geological formation 106 in the Earth crust. The geological formation 106 may be labeled as a rock formation, hydrocarbon formation, reservoir, hydrocarbon reservoir, and reservoir field. The geological formation 106 may be an unconventional formation to be subjected to hydraulic fracturing.

The wellbore 102 can be vertical, horizontal, or deviated. The wellbore 102 can be openhole but is generally a cased wellbore. The annulus between the casing and the formation 106 may be cemented. Perforations may be formed through the casing and cement into the formation 106. The perforations may allow both for flow of frac fluid into the geological formation 106 and for flow of produced hydrocarbon from the geological formation 106 into the wellbore 102.

The well site or well system 100 may have a hydraulic fracturing system including a source 108 of frac fluid 110 at the Earth surface 104 near or adjacent the wellbore 102. The frac fluid 110 may also be labeled as fracturing fluid, fracing fluid, or fracking fluid. The source 108 may include one or more vessels holding the frac fluid 110. The frac fluid 108 may be stored in vessels or containers on ground or on a vehicle, such as a truck. The frac fluid 110 may be a water-based fracturing fluid. In some implementations, the frac fluid 110 is slickwater that may be primarily water (for example, at least 98.5% water by volume). The frac fluid 110 can be prepared from seawater. The frac fluid 110 can also be gel-based fluids. The frac fluid 110 can include polymers and surfactants. Other additives to the frac fluid 110 may include hydrochloric acid, friction reducers, emulsion breakers, and emulsifiers. In certain embodiments of the frac fluid 110 include at least a high temperature stabilizer or a crosslinker, or both. Frac fluids 110 of differing viscosity may be employed in the hydraulic fracturing. The frac fluid 110 may include proppant.

A first additive 112 and a second additive 114 may be added to the frac fluid 110 at the well site 100. The additives may instead be added to the frac fluid 110 offsite prior to disposition of the frac fluid 110 at the well site 100. More than two additives may be added to the frac fluid 110. In certain embodiments, the first additive 112 is a crosslinker and the second additive 114 is a high temperature stabilizer. The concentration of the first additive 112 in the frac fluid 110 may be maintained or adjusted by modulating a flow rate of addition of the first additive 112 via a control component 116. Similarly, the concentration of the second additive 114 in the frac fluid 110 may be maintained or adjusted by modulating a flow rate of addition of the second additive 112 via a control component 118. The set points of the control components 116, 118 may be manually set or specified (directed) by a control system such as the control system 122.

The control components 116, 118 may each be a control valve on the respective conduit conveying the first additive 112 and second additive 114 to the source 108 (for example, vessel) of the frac fluid 110. The control components 116, 118 may each be a metering pump disposed along the respective conduit conveying the first additive 112 and the second additive 114. In some implementations for a metering pump, the speed of the pump may be adjusted to alter the flow rate of the additive. If a metering pump is employed, the respective metering pump may provide a motive force for the conveying of the first additive 112 and the second additive 114.

The hydraulic fracturing system at the well site 100 may include motive devices such as one or more pumps 120 to pump (inject) the frac fluid 110 through the wellbore 102 into the geological formation 106. The pumps 120 may be, for example, positive displacement pumps and arranged in series and parallel. Again, the wellbore 102 may be a cemented cased wellbore and have perforations for the frac fluid 110 to flow into (injected into) the formation 106. The system may include a control component to modulate or maintain the flow of frac fluid 110 into the wellbore 102 for the hydraulic fracturing. The control component may be, for example, a control valve(s). In some implementations, the control component may be the pump(s) 120 as a metering pump in which speed of the pump 120 is controlled to give the desired or specified flow rate of the frac fluid 110. The set point of the control component may be manually set or driven by a control system such as the control system 122.

The hydraulic fracturing system at the well site 100 may have a source of proppant which can include railcars, hoppers, containers, or bins having the proppant. Proppant may be segregated by type or mesh size (particle size). The proppant can be, for example, sand or ceramic proppants. The source of proppant may be at the Earth surface 104 near or adjacent the wellbore 102. The proppant may be added to the frac fluid 110 such that the frac fluid 110 includes the proppant. In some implementations, the proppant may be added (for example, via gravity) to a conduit conveying the frac fluid 110 such as at a suction of a frac fluid pump 120. A feeder or blender may receive proppant from the proppant source and discharge the proppant into a conduit conveying the frac fluid 110.

The frac fluid 110 may be a slurry having the solid proppant. The pump 120 discharge flow rates (frac rates) may include a slurry rate which may be a flow rate of a frac fluid 110 as slurry having proppant. The pump 120 discharge flow rates (or frac rates) may include a clean rate which is a flow rate of frac fluid 110 without proppant. In particular implementations, the fracturing system parameters adjusted may include at least pump(s) 120 rate, proppant concentration in the frac fluid 110, additive 112, 114 addition rates, and additive 112, 114 concentrations in the frac fluid 110. Fracturing operations can be manual or guided with controllers.

The well site 100 may include a control system 122 that may support or be a component of the hydraulic fracturing system. The control system 122 includes a processor 124 and memory 126 storing code 128 (logic, instructions) executed by the processor 124 to perform calculations and direct operations at the well site 100. The processor 124 may be one or more processors, and each processor may have one or more cores. The hardware processor(s) 124 may include a microprocessor, a central processing unit (CPU), graphic processing unit (GPU), or other circuitry. The memory may include volatile memory (for example, cache and random access memory (RAM)), nonvolatile memory (for example, hard drive, solid-state drive, and read-only memory (ROM)), and firmware. The control system 122 may include a desktop computer, laptop computer, computer server, programmable logic controller (PLC), distributed computing system (DSC), controllers, actuators, control cards, an instrument or analyzer, and a user interface. In operation, the control system 124 may facilitate processes at the well site 100 and including to direct operation of aspects of the hydraulic fracturing system.

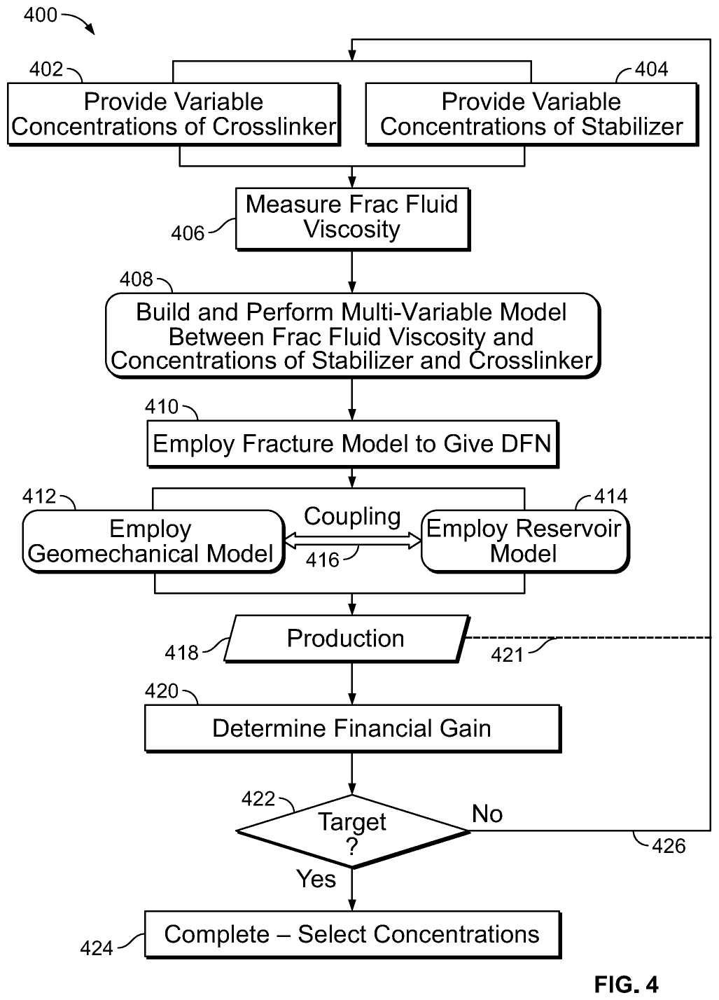

The control system 124 may perform simulation, modeling, and other actions discussed in the present disclosure including those of FIGS. 4-7. The control system 124 may be communicatively coupled to a remote computing system that performs simulation, modeling, and other actions of FIG. 4-7. The control system 124 may receive user input or remote computer input that specifies the set points of the control components 116, 118 or other control components in the hydraulic fracturing system. The control system 124 may specify the set point of the control components 116, 118 for the additive additions. In some implementations, the control system 124 may calculate or otherwise determine the set points of the control components 116, 118. The determination may be based on workflow aspects of FIGS. 4-7 performed by the control system 124, remote computer, or a user, or any combination thereof.

Surface equipment 130 at the well site or well system 100 may include equipment to drill a borehole to form the wellbore 102. The surface equipment 130 may include a mounted drilling rig which may be a machine that creates boreholes in the Earth subsurface. The term “rig” may refer to equipment employed to penetrate the Earth surface 104. Surface equipment 130 may include equipment for installation and cementing of casing in the wellbore, as well as for forming perforations through wellbore 102 into the geological formation 106. The surface equipment 116 may include equipment to support the hydraulic fracturing.

A crosslinker is a compound, typically a metallic salt or a borate salt, mixed with a gel fluid, such as a guar gel fluid, to create a viscous gel employed in oilfield well treatments. The crosslinker reacts with the multiple-strand polymer to couple the molecules, creating a fluid of high viscosity. Various frac fluid systems employ crosslinking agents such as zirconium compound crosslinkers or borate crosslinkers. Crosslinkers for the fracturing fluid may include zirconium (Zr) crosslinkers, typically having a ZrO₂ content of about 4 wt % to about 14 wt % or more. The fracturing fluid typically includes about 0.1 gallons per thousand gallons of fracturing fluid (gpt) to about 10 gpt of one or more such crosslinkers. Zirconium crosslinkers include, for example, zirconium lactates (such as sodium zirconium lactate), triethanolamines, 2,2′-iminodiethanol, and with mixtures of these ligands. Crosslinkers for fracturing fluid may also include titanium (Ti) crosslinkers. Titanate crosslinkers include, for example, titanate crosslinkers with ligands such as lactates and triethanolamines, and mixtures, and optionally delayed with hydroxyacetic acid. Crosslinkers for the fracturing fluid may also include borate crosslinkers, aluminum (Al) crosslinkers, chromium (Cr) crosslinkers, iron (Fe) crosslinkers, hafnium (Hf) crosslinkers, and combinations thereof.

A high-temperature stabilizer refers to a compound utilized to reduce the rate of oxygen-promoted degradation of polymers in well-treatment fluids at elevated temperatures. As the wellbore bottom hole temperature increases, the oxygen-promoted degradation rate typically increases. At high temperatures (e.g., above 200° F.), a high temperature stabilizer is often needed in the well treatment fluids. High temperature stabilizers for the fracturing fluid include oxygen scavengers (e.g., sodium thiosulfate). High temperature stabilizers also include sorbitol and derivatized sorbitol (e.g., commercially available alkylated sorbitol). At temperatures above 250° F., above 275° F., or above 300° F., the oxygen scavenger may be used in combination with sorbitol or derivatized sorbitol to achieve the fluid viscosity stability at the temperature tested.

Embodiments of the present workflow to determine and specify a composition for frac fluid may prepare groups of fluids with the same source water (for example, from the same groundwater sample or the same seawater sample) and with the prepared fluids having the same additives. The additives may include, for example, a gelling agent, an oxygen scavenger, a high temperature stabilizer, and a crosslinker. The high temperature stabilizer can be, for example, sodium thiosulfate, sorbitol, or alkylated sorbitol, or any combinations thereof, as well as the high-temperature stabilizers discussed above. The crosslinker can be, for example, a Zr crosslinker, a titanium (Ti) crosslinker, an aluminum (Al) crosslinker, or a borate crosslinker, or any combinations thereof, as well as the crosslinker compounds discussed above.

In an implementation, the additive concentrations are identical in a first group of the fluids except that the concentration of high temperature stabilizer is varied among the prepared fluids in the first group. The additive concentrations are identical in a second group of the fluids except that the concentration of a crosslinker is varied among the prepared fluids in the second group. The concentrations of the high temperature stabilizer and the crosslinker in the fluids may be varied to build a multi-variable model between the high-temperature stabilizer concentration, the crosslinker concentration, and viscosity of the fluid. The concentrations may be varied to affect (for example, increase) the viscosity of the fluid as a frac fluid while considering additive cost and the impact of viscosity on the hydraulic fracturing of a geological formation with the frac fluid.

A financial gain may be determined considering additive cost and predicted hydrocarbon production from the geological formation. Typically, the cost to escalate the amount of an additive to increase hydrocarbon production is less than the value of the increased amount of production. However, there are instances where the incremental gain in hydrocarbon production gives less value than the cost of the increased addition of additive. There are occurrences where an increase in the amount of additive in the fracturing fluid gives no incremental gain in hydrocarbon production or decreases hydrocarbon production.

### EXAMPLES

The Examples are given only as examples and not meant to limit the present techniques. Example 1 and Example 2 are presented. In Example 1, the concentration of the high temperature stabilized was varied. In Example 1, three fluids were prepared with source water from the same seawater sample. The three fluids had the same concentration of the same gelling agent, the same concentration of the same oxygen scavenger, and the same concentration of the same crosslinker, but with different respective concentrations of the same high temperature stabilizer.

In Example 2, the concentration of the crosslinker was varied. In Example 2, two fluids were prepared with source water from the same seawater sample. The two fluids had the same concentration of the same gelling agent, the same concentration of the same oxygen scavenger, and the same concentration of the same high temperature stabilizer, but with different respective concentrations of the same crosslinker.

### Example 1

The three fluids were prepared by adding four additives to respective source water from the same seawater sample. As mentioned, the four additives were the same for all three fluids. The four additives were a gelling agent, an oxygen scavenger, a crosslinker, and a high temperature stabilizer. Each of the three fluids had the same concentration of the gelling agent and the same concentration of the oxygen scavenger. Each of the three fluids had the same concentration of the crosslinker at 3 gpt (gallon per thousand gallons). The three fluids had different respective concentrations of the high temperature stabilizer. The concentration of the high temperature stabilizer in the three fluids was 3 gpt, 3.5 gpt, and 4 gpt, respectively. The high temperature stabilizer employed in Example 1 was an alkylated sorbitol.

The viscosity of the three fluids was measured at 280° F. with a Fann 50-type viscometer having a Grace M5600 High-Pressure High-Temperature (HPHT) rheometer utilizing a B5 bob. Fann Instrument Company, which has the FANN® trademark, has headquarters in Houston, Tex., USA. Grace Instrument Company has headquarters in Houston, Tex., USA. The measurements were performed under 400 pounds per square inch gauge (psig) of nitrogen. The fluid viscosity was measured following the schedule in American Petroleum Institute (API) Recommended Practice (RP) 39 (1998 Edition published May 1998). This API RP 39 schedule includes fluid shearing at a shear rate of 100 reciprocal seconds (s−1). The schedule includes a series of shearing ramps once the fluid temperature reaches within 5° F. of the test temperature. The series then occurs periodically every 30 minutes. The shear ramps are at this series of reciprocal seconds: 100, 75, 50, 25, 50, 75, and 100. The measured viscosity results are shown in FIG. 1.

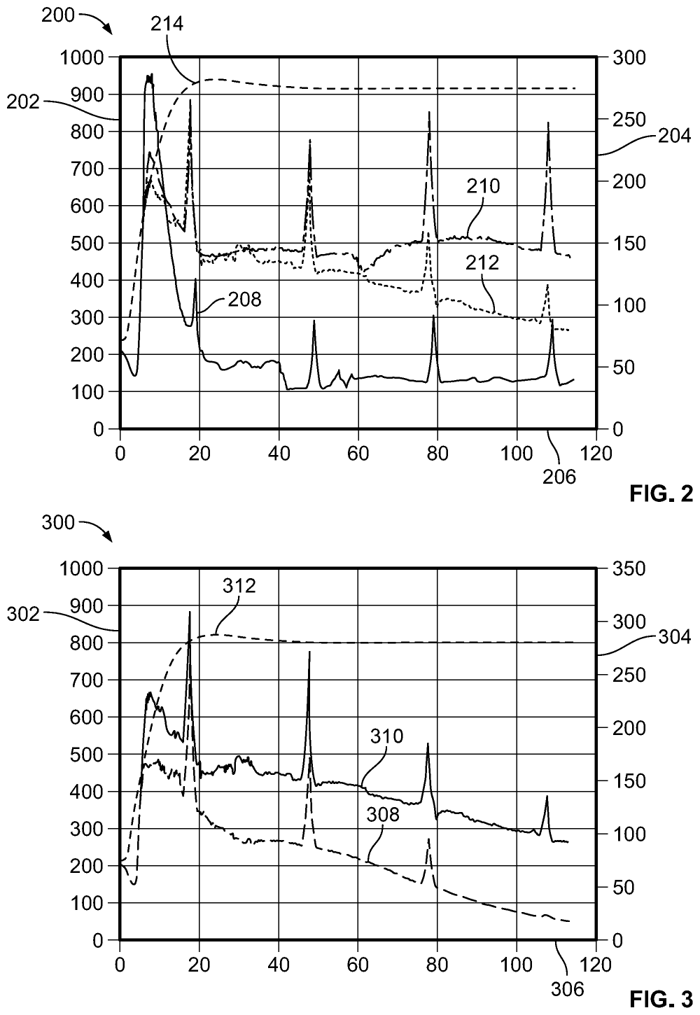

FIG. 2 is a plot 200 of fluid viscosity 202 in centipoise (cP) and the temperature 204 (° F.) over time 206 in minutes. The fluid viscosity 202 (cP) at 280° F. is plotted for the three fluids having the high temperature stabilizer at 3 gpt, 3.5 gpt, and 4 gpt, respectively. The curve 208 is viscosity 202 for the first fluid sample having a 3 gpt concentration of the high temperature stabilizer. The curve 210 is viscosity 202 of the second fluid sample having a 3.5 gpt concentration of the high temperature stabilizer. The curve 212 is viscosity 202 of the third fluid sample having a 4 gpt concentration of the high temperature stabilizer. The curve 214 is the temperature 204 of the viscosity measurements. The temperature curve 214 is an average of the temperature 204 for all three fluids.

The respective values for average viscosity of the three curves 208, 212, 214 are tabulated in Table 1. Based on the results given in Table 1, a beneficial concentration of the high temperature stabilizer may be near 3.5 gpt because the 3.5 gpt concentration of high temperature stabilizer gave greater fluid viscosity than the other two concentrations. Table 1 gives the average fluid viscosity at 280° F. for the three fluids containing the high temperature stabilizer at 3, 3.5, and 4 gpt, respectively.

TABLE 1
Average Fluid Viscosity at 280° F.

| | High Temperature | |
|---|---|---|
| | Stabilizer | Average Fluid |
| Fluid | Concentration (gpt) | Viscosity (cP) |
| 1 | 3 | 199 |
| 2 | 3.5 | 484 |
| 3 | 4 | 400 |

### Example 2

In the laboratory, the two fluids were prepared by adding four additives to respective source water from the same seawater sample. The four additives were the same for both fluids. The four additives were a gelling agent, an oxygen scavenger, a high temperature stabilizer, and a crosslinker. Both fluids had the same concentration of the gelling agent and the same concentration of the oxygen scavenger. Both fluids had the same concentration of the high temperature stabilizer at 4 gpt. The two fluids had different concentrations of the crosslinker at 2.5 gpt and 3 gpt, respectively. The crosslinker in Example 2 was a Zr crosslinker. The viscosity of the two fluids was measured at 280° F. with the Fann 50-type viscometer as described earlier. The results are plotted in FIG. 3. The average viscosity for each curve for the two fluids is tabulated in Table 2.

FIG. 3 is a plot 300 of fluid viscosity 302 in centipoise (cP) and the temperature 304 (° F.) over time 306 in minutes. The fluid viscosity 302 (cP) at 280° F. is plotted for the two fluids (of Example 2) having the crosslinker at 2.5 gpt and 3 gpt, respectively. The curve 308 is viscosity 302 for the first fluid sample having a 2.5 gpt concentration of the crosslinker. The curve 310 is viscosity 302 of the second fluid sample having a 3 gpt concentration of the crosslinker. The curve 312 is the temperature 304 of the viscosity measurements. Table 2 gives the average fluid viscosity at 280° F. for the fluids containing the crosslinker at 2.5 and 3 gpt, respectively.

TABLE 2
Average Fluid Viscosity at 280° F.

| | Crosslinker | Average Fluid |
|---|---|---|
| Fluid | Concentration (gpt) | Viscosity (cP) |
| 1 | 2.5 | 220 |
| 2 | 3 | 484 |

FIG. 4 is a method or workflow 400 to determine compositions for a hydraulic fracturing fluid to achieve hydrocarbon production from a geological formation at beneficial economic impact. The beneficial economic impact may be financial gain at or approaching a maximum.

At blocks 402 and 404, frac fluids are prepared with variable concentrations of crosslinker and high temperature stabilizer, respectively. The concentrations of the crosslinker and the concentrations of the high temperature stabilizer may be, for example, in weight percent of the frac fluid. A purpose of preparing the frac fluids may be to measure viscosity of the frac fluid in the laboratory or field. The amount of each frac fluid prepared may be, for example, less than 5 liters for measurement of viscosity in the laboratory.

At block 406, the viscosity of each frac fluid prepared is measured. For example, the viscosity of the frac fluid or of a sample of the frac fluid is measured in the laboratory. The viscosity may be reported, for example, in centipoise (cP) at a given temperature in degree Celsius (° C.).

At block 408, the workflow builds a multi-variable model between frac fluid viscosity and concentration values of stabilizer and crosslinker in the frac fluid. The workflow relies on the measured values of viscosity to construct the multi-variable model.

After the multi-variable model is built and programmed, the variable concentrations in blocks 402 and 404 may be specified without preparation of the frac fluid and thus without the measuring (block 406) of viscosity. The concentrations in blocks 402 and 404 may be specified and the multi-variable model determines or predicts the viscosity of the frac fluid based on the specified concentrations.

At block 410, a hydraulic fracture model receives viscosity values of considered frac fluids. The fracture model is employed based on the prepared or specified frac fluids and properties of the geological formation. The fracture model considers the viscosity of the frac fluids. The fracture model simulates hydraulic fracturing to give a discrete fracture network (DFN). A DFN may be generated for each frac-fluid composition considered.

At blocks 412 and 414, the fractures simulated by the fracture model and the produced DFN for each case may be coupled with a geomechanical model and reservoir model, respectively. The geomechanical model and the reservoir model may also be coupled, as indicated by arrow 416.

The geomechanical model may encompass numerical geomechanical modeling to combine the numerical analyses with existing geometric and kinematic data to produce testable predictions. Geomechanical modeling may handle various geometries and material models to temporally and spatially analyze stresses and deformations. The geomechanical model can implement continuum or discontinuum mechanics-based techniques. The geomechanical model may analyze wellbore stability and associated geological formation aspects. The aspects can include state of stress, pore pressure, and rock properties (for example, strength). The state of stress can include the orientations and magnitudes of the three principal stresses. The rock strength can be anisotropic in shale formations. As for pore pressure, the small permeability (for example, less than 1 millidarcy) and small pore volume of unconventional formations (for example, shale) can inhibit direct measurement of pore pressure. The geomechanical model may implement pore-pressure-prediction techniques. The geomechanical model may determine overburden pressure (Sᵥ,) that may generally be equal to the weight of overlying fluids and rock.

A geomechanical model can reveal the mechanical behavior of rocks and be employed to manage reservoir programs. In the geological formation, fluid pressure may be reduced during hydrocarbon production from a reservoir. This reduction of pressure may increase the effective stress due to overburden sediments and may cause porous media compaction and surface subsidence.

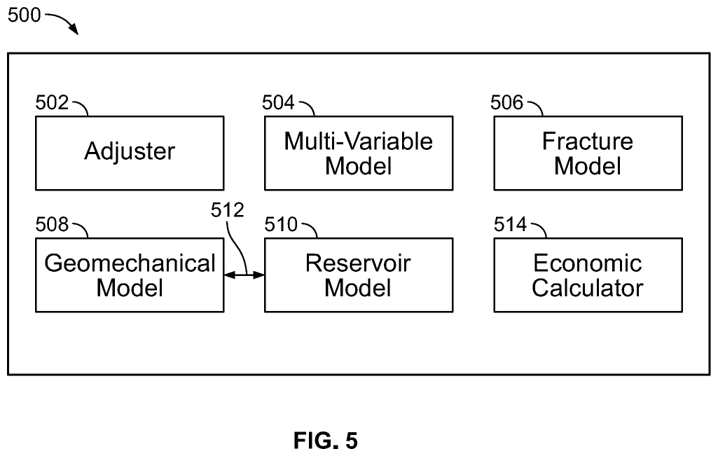

A reservoir model that simulates petroleum reservoir performance may refer to the construction and operation of a mathematical model whose behavior assumes the actual reservoir behavior. A mathematical model may be a set of equations that, subjected to certain assumptions, describe the physical processes active in the reservoir. Although the model itself may lack the reality of the reservoir, the behavior of a valid model may simulate (assume the appearance of) the actual reservoir. A purpose of simulation may be estimation of field performance (for example, oil recovery) under one or more producing schemes. Whereas the field can be produced only once, a model can be produced or run many times. Observation of model results that represent different producing conditions aids selection of an optimal or improved set of producing conditions for the reservoir. Exemplary inputs to the geomechanical model and the reservoir model are discussed later with respect to FIG. 5.

The output of the geomechanical and reservoir models may be a prediction of hydrocarbon production 418 for each frac-fluid composition case simulated. The hydrocarbon may be crude oil or natural gas, or both. The hydrocarbon production 418 is from a geological formation after simulated fracturing of the geological formation with the respective prepared or specified frac fluids. The production 418 may be related to the amount and complexity of hydraulic fracturing (for example, as indicated in the DFN), which may be affected by the viscosity of the frac fluid. In some implementations, frac fluid with less viscosity (for example, less than 100 cP) may promote complex fracturing that can increase hydrocarbon recovery from the geological formation reservoir and thus increase hydrocarbon production 418. A more viscous frac fluid (for example, greater than 100 cP) may convey proppant deeper into the fractures and thus increase hydrocarbon production 418. In certain implementations, the amount of crosslinker or high temperature stabilizer, or both, may be increased or decreased to achieve a beneficial viscosity. The simulated DFN via the hydraulic fracture model and the simulated production flow via the reservoir model and the geomechanical model may facilitate determining the beneficial viscosity to increase production 418. The production 418 may be expressed as a rate of hydrocarbon production in amount of hydrocarbon per time. The production 418 may be expressed as total hydrocarbon recovered from a well in the geological formation. The production 418 may be expressed as percent of hydrocarbon in a geological formation recovered via the well.

In some instances, the workflow 400 may not immediately proceed to block 420 but instead a decision is made by the workflow 400 to return 421 to the varying of concentration of the crosslinker (block 402) or varying concentration of the high temperature stabilizer (block 404) in the frac fluid. The decision can be made, for example, based on the hydrocarbon production 418 value output by the geomechanical and reservoir models not being within a specified range. The blocks 402 through 414 can be repeated until the hydrocarbon production 418 converges within a desired range. Then, the workflow may proceed to block 420. However, the workflow may proceed directly to block 420 without an internal secondary iteration (e.g., via return 421) to converge the production 418 value. The predicted production 418 is the hydrocarbon production that occurs after the simulated implementation of hydraulic fracturing with the considered frac fluids.

At block 420, the workflow considers the hydrocarbon production 418 to predict financial gain. The workflow determines or calculates financial gain based at least on the production 418. The determination or calculation of financial gain may also consider additive cost. When the additive dose is increased, the cost of the fracturing fluid increases. Yet, the viscosity of the fracturing fluid may also increase. The increased viscosity may lead to longer and more complex fractures that leads more production. The financial benefit of the enhanced production is usually larger than the additive cost increase.

A financial gain may be determined for each case of prepared or specified frac fluid. The financial gain may be in units of financial units or monetary currency, such as United States dollars ($) or Saudi Arabian Riyals (SAR). The financial gain may be based on the production 418 after the modeled fracturing. The value (including per-unit value) of the estimated production 418 may be considered. The costs (including per-unit costs) of the crosslinker and high temperature stabilizer may be considered. The workflow may identify an estimated production 418 value that approaches a maximum difference (for example, profit margin) between the estimated production 418 value and the costs of the crosslinker and high temperature stabilizer.

In a hypothetical example, an iteration of the workflow may determine a cost of the amounts of the crosslinker and high temperature stabilizer utilized in a hydraulic fracturing job at $5000 and that gives a subsequent production 418 value of $100,000. The financial gain (or this aspect of the financial gain) is $95,000. The next iteration of the workflow may determine a cost of the amounts of the crosslinker and high temperature stabilizer utilized at $6000 and that gives a production 418 value of $110,000. The financial gain (or this aspect of the financial gain) is $104,000. The later iteration results in a greater gain in dollars.

At decision diamond 422, the workflow may check whether the financial gain is maximized. The check may determine whether the financial gain is approaching a maximum (for example, within 10% of a target). If the additive dose is increased over the optimum value, the increase of additive dose over the optimum amount will not further enhance the frac fluid (performance of the frac fluid). Thus, there exists a maximum financial benefit.

The check may be a mathematical or numerical convergence through the iterations of the workflow 400. Convergence parameters may be input or specified by a user. The workflow may determine whether the financial gain has reached or converged on a maximum financial gain (or for example, within 5% or 10% of the maximum financial gain). The workflow may determine if the calculated financial gain has reached a target. The target may have the units of the financial gain. The target may be, for example, within 10% or 20% of a specified maximum financial gain.

If the workflow has not converged on a maximum financial gain or reached the target, the workflow continues (returns) 426 to the varying of concentration of the crosslinker (block 402) or high temperature stabilizer (block 404) in the frac fluid, or both. If the workflow has converged on a maximum financial gain or reached the target, the workflow may be complete 424 with selection of the concentration of the crosslinker and the concentration of the high temperature stabilizer. At 424, a selected output of the frac fluid composition is established.

In certain implementations, the action of selecting output concentrations by the workflow (at 424) can be incorporated in (or utilized by) a control system (for example, control system 122). The control system via the workflow may change set points of control components (for example, 116, 118) to adjust the respective addition rates of crosslinker and high-temperature stabilizer to the frac fluid.

FIG. 5 is a computing system 500 that determines a composition to specify for a frac fluid. The determination includes specifying concentration of a crosslinker in the frac fluid and specifying a concentration of a high temperature stabilizer in the frac fluid. The computing system 500 may be a computer or distributed computing system. The computing system 500 may be situated at a single location or disposed across multiple geographic locations. The computing system 500 may be for hydraulic fracturing. The computing system 500 may specify crosslinker concentration and stabilizer concentration in a frac fluid for hydraulic fracturing. The computing system 500 may be a component of a control system (for example, control system 122 at the well site 100) that directs hydraulic fracturing of a geological formation.

The computing system 500 includes an adjuster 502 to vary the considered concentrations of the crosslinker and the high temperature stabilizer. The adjuster 502 may change or specify the concentrations in response to model outputs and production or financial-gain calculations by the computing system. The adjuster 502 may change or specify the concentrations to converge a workflow (performed by the computing system) to a maximum or target of financial gain. The computing system may have a user interface for a user to input values for the concentrations to the adjuster 502. In some implementations, the user may input starting values for the concentrations and alter concentration values throughout the modeling.

The computing system 500 includes a multi-variable model 504 correlating frac fluid viscosity, frac-fluid stabilizer concentration, and frac-fluid crosslinker concentration. In operation, the multi-variable model 504 determines or predicts the viscosity of the frac fluid as a function of (correlative with) the concentration of the crosslinker in the frac fluid and the specified concentration of the high temperature stabilizer in the frac fluid. The concentrations are specified by the adjuster 502.

The computing system 500 includes a hydraulic fracture model 506 to simulate hydraulic fracturing of a geological formation and output simulated fractures and a DFN. The fracture model 506 may receive information about a well system (for example, well system 100) and properties of the geological formation as inputs. The properties may include stiffness and strength of the geological formation. The hydraulic fracture model 506 can accept information including in-situ stresses and pore pressure in the geological formation, heterogeneity in the geological formation, mechanical properties of the heterogeneities, and elastic stiffness and plastic strength properties of geological formation rocks. In some implementations, some of these properties can be measured in a rock mechanics lab and provided for use by the hydraulic fracture model 506. The hydraulic fracture model 506 can consider injection plans for a fracturing job and the viscosity of the frac fluid.

In operation, the hydraulic fracture model 506 simulates a main hydraulic fracturing stimulation based on the inputs. In the simulation performed by the hydraulic fracture model 506, some existing natural fractures can be reactivated, new fractures can be created, and proppants can be placed in the created fractures. As a result of this simulation, a stimulated reservoir volume (SRV) consisting of new fractures or reactivated natural fractures (or both) will be determined. The output of the hydraulic fracture model 506 is a DFN consisting of a description of a number of fractures and where each fracture can be characterized by length, width, height, and orientation.

The computing system 500 includes a geomechanical model 508 to receive the DFN and estimate an amount of hydrocarbon production that the geological formation can provide based on the DFN. In some implementations, the geomechanical model 508 can receive additional information about a well system. For example, the geomechanical model 508 can accept information including in-situ stresses and pore pressure in the reservoir field of the geological formation, rock mass of reservoir layers, and constitutive models of rock mass that describe the stress-deformation-failure process of geological formation under various loading modes. The accepted information can include mechanical properties of rock mass, mechanical properties of fractures, fluid mechanical interaction parameters, and thermal mechanical coupling parameters. In certain implementations, some of these properties can be measured in a rock mechanics lab and provided for use by the geomechanical model 508.

The computing system includes a reservoir model 510 to receive the DFN from the fracture model 506 and estimate an amount of hydrocarbon production that the geological formation can provide based on the DFN. In some implementations, the reservoir model 510 can receive additional information about the well system and geological formation. The reservoir model 510 can accept information including initial reservoir-pressure distribution information of the geological formation, reservoir-temperature distribution information, multiphase flow models for fluid flow in rock, multiphase flow models for fluid flow in the DFN, thermal conduction models, convection models, rock porosity, rock permeability, saturation levels, thermal conduction properties of rock, convective properties of rock, well location, drawdown plans, and temperature at the production well or wellbore.

The geomechanical model 508 and the reservoir model 510 are bidirectionally coupled 512 to each other. For example, the reservoir model 508 can be at least partly driven by a drawdown plan at the well system. In such implementations after thermal and fluid flow modeling is performed, updated pore pressure and temperature parameters can be transferred from the reservoir model 510 to the geomechanics model 508. Then, the geomechanical modeling can be performed to bring the system to equilibrium. The geomechanical model can estimate deformation, mechanical damage, and failure in the rock formation to update porosity and permeability parameters. Updated aperture or other geometric parameters of the DFN can be based on the deformation of the DFN. In such implementations, updated geometric or mechanical properties (or both) of rock mass or the DFN (or both the rock mass and the DFN) can then be transferred from the geomechanical model 508 to the reservoir model 510. The reservoir model 510 can perform further estimation based on these updated parameters.

An output of the reservoir model 510 and the geomechanical model 508 is an estimated production value. In an implementation, the following ideal “Darcy”, steady state, radial flow equation (1) can be utilized to calculate the inflow performance of a fully penetrating, damaged, vertical, open hole well in a homogeneous formation: (1) q_{w}=0.00708 kh(pᵣ−p_{w})/Bμ[ln(rₑ/r_{w})+S], where q_{w} is the well flow rate; k is permeability (millidarcy); h is the thickness of reservoir layer (feet); pᵣ is the reservoir pressure (pounds per square inch or psi); p_{w} is the flowing bottom hole pressure (psi); B is the formation volume factor; p is the viscosity of reservoir fluid (centipoise); rₑ is drainage radius (feet); r_{w} is the well radius (feet); and S is the skin factor.

The computing system 500 includes an economic calculator 514 determine a financial gain associated with the estimated production value output by the geomechanical and reservoir models. The variables in a financial gain calculation may enhanced production and additive cost. In some implementations, the financial gain may equal the value (dollars) of production or increased production minus the additive cost or increased additive cost.

The economic calculator 514 or a decider (decider module) may determine that the current stabilizer concentration and current crosslinker concentration give a frac-fluid viscosity that promotes hydraulic fracturing resulting in a maximum (or target) financial gain. The economic calculator 514 or decider component may determine that the financial gain has reached a maximum or target (value or a range of values). If the maximum or target has not been reached, the economic calculator 514 or decider may return the workflow (iteration) to the adjuster 502. If the predicted financial gain has reached a maximum or target, the stabilizer concentration and crosslinker concentration may be selected and output (and thus the frac-fluid composition established at least for these two components). In one implementation, the computer 500 may specify control in a hydraulic fracturing system. The control may be related to concentrations or addition rates of the stabilizer and crosslinker.

The components 502, 504, 506, 508, 510, and 514 can be implemented as computer instructions stored on a computer-readable medium and executable by one or more processors. Alternatively or in addition, the components 502, 504, 506, 508, 510, and 514 can be implemented in hardware or firmware or a combination of hardware, firmware, and software.

An embodiment is a computing system to specify crosslinker concentration and stabilizer concentration in a frac fluid for hydraulic fracturing. The crosslinker concentration in the frac fluid and the stabilizer concentration in the frac fluid may each be in a range of 1 gallon per thousand gallons (gpt) to 10 gpt. The stabilizer may be a high temperature stabilizer. The computing system includes a hydraulic fracture model to receive a value of viscosity of a frac fluid and output a DFN correlative with the value of the viscosity. The hydraulic fracture model may receive the value of viscosity as a user input. The computing system may have a multi-variable model that correlates the viscosity with the crosslinker concentration and the stabilizer concentration. The hydraulic fracture model may receive the value of viscosity from the multi-variable model. The computing system includes a geomechanical model and a reservoir model. The geomechanical model and the reservoir model are coupled to give a hydrocarbon production correlative with the DFN. The computing system includes an economic calculator to determine financial gain correlative with the crosslinker concentration, the stabilizer concentration, and the hydrocarbon production. The computing system may include an adjuster to vary the stabilizer concentration and the stabilizer concentration to change the value of the viscosity to increase the financial gain.

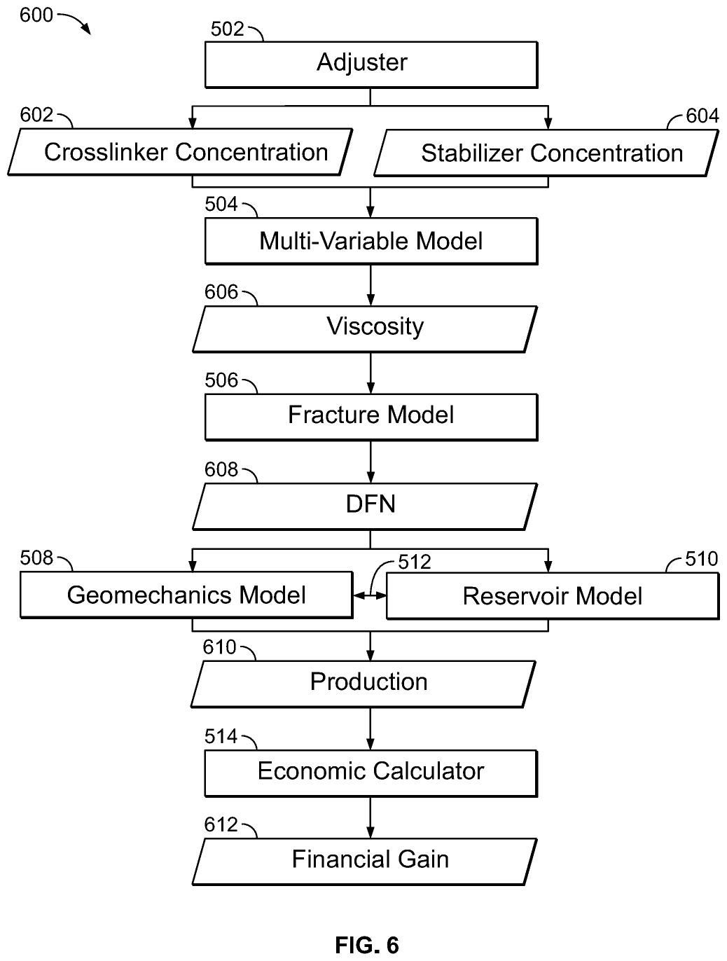

FIG. 6 is a block flow diagram 600 of component outputs and relationships in operation of the computing system 500 (FIG. 5). The adjuster 502 outputs a crosslinker concentration 602 for a frac fluid. The adjuster 502 outputs a high-temperature stabilizer concentration 604 for the frac fluid. The concentrations 602, 604 may be, for example, in weight percent of the frac fluid.

The multi-variable model 504 receives the concentration 602, 604 values. The multi-variable model 504 determines a viscosity of the frac fluid based on (correlative with) the crosslinker concentration 602 and the high-temperature stabilizer concentration 604. The concentrations 602, 604 may be as specified by the adjuster 502 for the frac fluid. The multi-variable model 504 outputs a viscosity 606 value correlative with the concentrations 602, 604.

The hydraulic fracture model 506 receives the viscosity 606 value output by the multi-variable model 504. The hydraulic fracture model 506 simulates hydraulic fracturing of a geological formation with a frac fluid having the viscosity 606 and the associated crosslinker concentration 602 and stabilizer concentration 604. The hydraulic fracture model 506 outputs a DFN 608 based on the simulation.

The geomechanics model 508 and the reservoir model 510 may each receive the DFN 608 output from the hydraulic fracture model 506. The geomechanics model 508 and the reservoir model 508 may output a predicted production 610 based on the DFN. The estimated production 610 may represent a rate of hydrocarbon production or an accumulated production of hydrocarbon. In some implementations, the iterations of estimated production 610 can be analyzed to identify an estimated production 610 that approaches a target parameter. In a particular implementation, the greatest production 610 can be selected and the associated crosslinker concentration 602 and high-temperature stabilizer concentration 604 selected for the frac fluid in the hydraulic fracturing.

The geomechanics model 508 and the reservoir model 510 are interactively coupled 512 in the programmed code and execution. The reservoir model 510 may involve reservoir characterization and can include geological factors and fluid characteristics of the reservoir. Reservoir modeling may involve the construction of a computer model of a petroleum reservoir for the purposes of improving estimation of reserves of the field, making decisions regarding the development of the field, predicting future production of the field, placing additional wells in the field, and evaluating alternative reservoir management scenarios.

The geomechanical model 508 may account for temperature and pore pressure distributions in the geological formation. The model 508 may represent the rheological behavior of the simulated rocks in the formation, which can range from simple linear elastic to complex inelastic materials. When coupled with actual rock properties, geomechanical simulation may present, for example, a geometric and kinematic restoration. The spatial and temporal distribution of variables (for example, stress, strain, temperature, and pore pressure) may be available during the geomechanical simulation.

The coupling of geomechanical model 508 and the reservoir model 510 can be implemented to make predictions. In the coupling, the geomechanical model 508 may update the stress and pore pressure based on the updated pore pressure in the reservoir model 510. The updated stress and pore pressure are utilized to update the permeability and porosity of rock matrix (and aperture and pressure distribution along fractures) in reservoir model 510 for the next computation. The models 508, 510 can be run multiple times to approach a selected objective.

The economic calculator 514 receives the hydrocarbon production 610 value output by the models 508, 510. The economic calculator 514 determines and outputs a financial gain 612. A calculation of financial gain may be related to enhanced production minus additive cost.

A determination may be made whether the financial gain has reached or converged on a maximum or target. The determination may be made, for example, by the economic calculator 514, the adjuster 502, or a decider component. If the financial gain has not reached a maximum or target, the adjuster 502 may specified new values for crosslinker concentration 602 or the high-temperature concentration 604, or both. If the financial gain has reached a maximum or a target, the iterations may be completed. Thus, the current values for the concentrations 602, 604 at completion may be selected or specified for the frac fluid to be implemented in hydraulic fracturing in the field.

An embodiment is a computing system for hydraulic fracturing. The computing system includes a multi-variable model that correlates viscosity of a frac fluid with a crosslinker concentration of the frac fluid and a stabilizer concentration of the frac fluid. The computing system includes a hydraulic fracture model to receive a viscosity value of the frac fluid from the multi-variable model, simulate hydraulic fracturing of a geological formation with the frac fluid, and output a DFN correlative with the viscosity. The computing system includes a geomechanical model and a reservoir model coupled to give an amount of hydrocarbon production correlative with the DFN. The computing system includes an adjuster to change the crosslinker concentration in the multi-variable model and the stabilizer concentration in the multi-variable model. The computing system may include an economic calculator to determine financial gain correlative with the crosslinker concentration, the stabilizer concentration, and the hydrocarbon production. The adjuster may change the crosslinker concentration and the stabilizer concentration in response to at least the amount of hydrocarbon production.

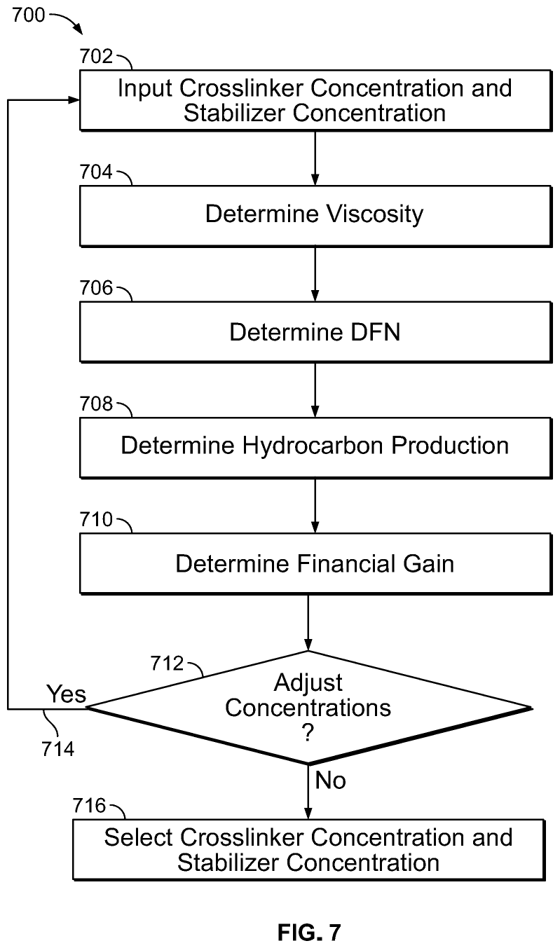

FIG. 7 is a method 700 for hydraulic fracturing. The method is determining or specifying a composition for a frac fluid. The method may specify crosslinker concentration and stabilizer concentration in a frac fluid for hydraulic fracturing.

At block 702, the method includes inputting values for crosslinker concentration in a frac fluid and for high-temperature stabilizer concentration in the frac fluid. Hydraulic fracturing may be simulated (block 706) based on the values. The values of crosslinker concentration and stabilizer concentration may be input by a computer-implemented workflow or iteration. The values input may be adjusted values in an effort to reach a target hydrocarbon production or target financial gain after the hydraulic fracturing. The values may be input by a user.

At block 704, the method includes determining a viscosity of a frac fluid having the input values of crosslinker concentration and high-temperature stabilizer concentration. In some implementations, a multi-variable model determines the viscosity as a function of the crosslinker concentration and high-temperature stabilizer concentration.

At block 706, the method includes determining a DFN by simulating hydraulic fracturing (of a geological formation) that utilizes the frac fluid. The frac fluid considered is the frac fluid having the determined viscosity and associated inputted concentrations for stabilizer and crosslinker. Thus, the method may include simulating, via the hydraulic fracture model, hydraulic fracturing of a geological formation with the frac fluid having the determined viscosity.

At block 708, the method includes determining (predicting) hydrocarbon production based on the simulated DFN output from block 706. A geomechanical model and a reservoir model may be employed to simulate the hydrocarbon production to give a predicted production based on the DFN. The predicted production may be simulated hydrocarbon production occurring after (and in response to) the hydraulic fracturing simulated in block 706. The predicted hydrocarbon production may be the estimated hydrocarbon production that would occur if the hydraulic fracturing simulated at block 706 was actually implemented in the geological formation. The simulated hydraulic fracturing if performed in the field may be via a hydraulic fracturing system at a well site and performed through a wellbore in the geological formation.

At block 710, the method includes determining financial gain. To determine the financial gain, the monetary value of the predicted hydrocarbon production including any increase in the hydrocarbon production may be considered. The hydrocarbon may include crude oil or natural gas, or both. An increase in hydrocarbon production or recovery may generally increase the financial gain. The hydrocarbon production rate and timing may be evaluated in view of any fluctuating sales prices of the hydrocarbon over time. In determining financial gain, the amount of the crosslinker and high temperature stabilizer added to the frac fluid may be considered. The cost of the crosslinker and high temperature stabilizer may generally decrease the financial gain. A particular consideration may be increased cost due to increasing the amount of crosslinker or high temperature stabilizer to reach a desired frac-fluid viscosity or hydrocarbon production. An aspect of determining financial gain may be the cost of hydraulic fracturing. A shortened time of a hydraulic-fracturing job due, for example, to viscosity of the frac fluid may decrease cost of the hydraulic fracturing. The sales of hydrocarbon production, cost of additives, and cost of a hydraulic fracturing job may be incorporated in the analysis or calculation to determine financial gain.

At decision diamond 712, the method includes deciding based on the predicted financial gain (block 710) whether to adjust the concentrations of crosslinker and high temperature stabilizer in the frac fluid in the iterating or simulation. If yes, then the method returns 714 to block 702 to input new concentrations (for example, by an adjuster module or user) to reiterate (through the models) within the method 700. If no, then the method selects the current values on crosslinker concentration and stabilizer concentration, as indicated in block 716. These concentration values may be implemented to establish composition of frac fluid in hydraulic fracturing in the field.

An embodiment is a method of specifying a composition for a frac fluid including varying a crosslinker concentration in the frac fluid, varying a stabilizer concentration in the frac fluid, and determining viscosity of the frac fluid. The crosslinker may be a zirconium (Zr) crosslinker, a titanium (Ti) crosslinker, an aluminum (Al) crosslinker, or a borate crosslinker, or any combinations thereof. The stabilizer is a high temperature stabilizer that may be sodium thiosulfate, sorbitol, or alkylated sorbitol, or any combinations thereof. In implementations, the varying of the concentrations may be to vary the crosslinker concentration and the high-temperature stabilizer concentration as inputs to a multi-variable model. The determining of the viscosity may involve measuring the viscosity. The determining of the viscosity may include determining the viscosity with a multi-variable model that correlates the viscosity with the crosslinker concentration and the stabilizer concentration. The method may include building a multi-variable model between the viscosities as measured, the crosslinker concentrations, and the stabilizer concentrations. The method includes determining a DFN correlative with the viscosity, which may include simulating via a fracture model the hydraulic fracturing of a geological formation with the frac fluid. The method includes determining hydrocarbon production correlative with the DFN by employing a geomechanical model and a reservoir model. The geomechanical model and the reservoir model may be coupled. The method may include determining a financial gain correlative with the crosslinker concentration, the stabilizer concentration, and the hydrocarbon production. The method may include iterating through the varying of the crosslinker concentration and the varying of the stabilizer concentration to increase the financial gain.

Yet another embodiment is method of determining a composition for a frac fluid. The method includes determining viscosity for the frac fluid. The viscosity is affected by a crosslinker concentration for the frac fluid and a stabilizer concentration for the frac fluid. The viscosity may be determined via a multi-variable model between the viscosity, the crosslinker concentration, and the stabilizer concentration. The method includes employing a hydraulic fracture model to simulate hydraulic fracturing of a geological formation with the frac fluid. The hydraulic fracture model may receive a value of the viscosity as determined. Thus, the simulating of the hydraulic fracturing with the frac fluid may incorporate the value of viscosity. An output of the hydraulic fracture model is a DFN. The method includes employing a geomechanical model and a reservoir model to give hydrocarbon production from the geological formation based on the DFN. The method includes determining a financial gain correlative with the crosslinker concentration, the stabilizer concentration, and the hydrocarbon production. The method includes adjusting the crosslinker concentration for the frac fluid and the stabilizer concentration for the frac fluid to increase the financial gain. The method may include specifying a selected crosslinker concentration for the frac fluid and a selected stabilizer concentration for the frac fluid based on the financial gain. The crosslinker concentration in the frac fluid and stabilizer concentration (a high temperature stabilizer) each may be in a range of 1 gpt to 10 gpt.

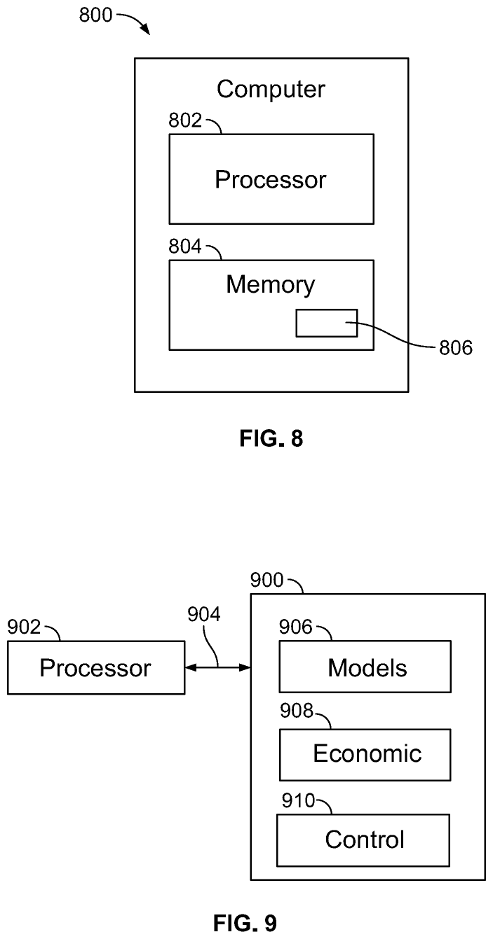

FIG. 8 is a computing system 800 having a processor 802 and memory 804 storing code 806 (for example, logic or instructions) executed by the processor 802. The code 806 may include the components depicted in FIG. 5. The code 806 can include an adjuster to determine or specify concentrations (for example, weight concentrations) of a crosslinker and a high-temperature in a frac fluid. The frac fluid may be an actual prepared frac fluid or a simulated frac fluid. The code 806 may include a multi-variable model that correlates viscosity of frac fluid with concentrations of a crosslinker and a stabilizer in the frac fluid. The code 806 may include a hydraulic facture model, a geomechanical model, and a reservoir model. The code 806 may include an economic calculator to determine financial gain associated with hydraulic fracturing and subsequent hydrocarbon production, as simulated or to be implemented. The code 806 may include a decider to determine if frac-fluid concentrations of crosslinker and high temperature stabilizer lead to maximum or target financial gain based on simulations and model outputs discussed earlier. The code 806 may include a controller to specify, for example, addition rates of crosslinker and high temperature stabilizer to frac fluid in a hydraulic fracturing system.

The computing system 800 may be single computing device, a server, a desktop, a laptop, multiple computing devices or nodes, a distributed computing system, or a control system or component of a control system. The processor 802 may be one or more processors and may have one or more cores. The hardware processor(s) 802 may include a microprocessor, a CPU, a GPU, or other circuitry. The memory 804 may include volatile memory (for example, cache or RAM), nonvolatile memory (for example, hard drive, solid-state drive, or ROM), and firmware. The computing system 800 may be programmed via the code 806 stored in memory 804 and executed by the processor 802 to perform actions discussed throughout the present disclosure including at least with respect to FIGS. 4-7.

The computing system 800 improves, for example, the technologies of hydraulic fracturing, well performance evaluation, and the production of hydrocarbons from a geological formation. In addition, the computing system 800 is an improved computing system via the code 806 in providing for timely determining effective frac-fluid composition and viscosity including in relation to predicted hydrocarbon production. Such is plainly unconventional in recognizing and considering the particular combination of crosslinker and high-temperature stabilizer as impactful on frac-fluid viscosity, the hydraulic fracturing job, and subsequent hydrocarbon production.

FIG. 9 is a block diagram depicting a tangible, non-transitory, computer (machine) readable medium 900 to facilitate determining, predicting, or specifying frac-fluid composition, frac-fluid viscosity, hydrocarbon production after hydraulic fracturing with the frac fluid, and associated financial gain. The computer-readable medium 900 may be accessed by a processor 902 over a computer interconnect 904. The processor 902 may be a controller, a control system processor, a controller processor, a computing system processor, a server processor, a compute-node processor, a workstation processor, a distributed-computing system processor, or a remote computing device processor. The processor 902 may be analogous to the processor 802 of FIG. 8 or the processor 124 of FIG. 1.

The tangible, non-transitory computer-readable medium 900 may include executable instructions or code to direct the processor 902 to perform the operations or actions of the techniques described in the present disclosure. The various executed code components discussed may be stored on the tangible, non-transitory computer-readable medium 900, as indicated in FIG. 9.

For example, a models code 906 may include a multi-variable model that correlates frac-fluid viscosity with frac-fluid concentrations of crosslinker and high temperature stabilizer. The models code 906 include a hydraulic fracture model to give a DFN. The models code 906 may include a geomechanical model and a reservoir model to receive the DFN and output a predicted hydrocarbon production. The geomechanical model and reservoir model may be bi-directionally coupled or integrated.

The economic code 908 may include executable instructions to direct the processor 906 to predict financial gain associated with simulated conditions. The simulated conditions can include frac-fluid composition, frac-fluid viscosity, and hydrocarbon production after hydraulic fracturing. The economic code 908 may determine which of the iterated conditions in the models and simulations give a maximum or target financial gain. The economic code 908 may output the conditions that converge on (or satisfy) the target financial gain. The output conditions may include stabilizer concentration and high-temperature stabilizer concentration in the frac fluid.

The control code 910 may include executable instructions to direct the processor 902 guide control of a hydraulic fracturing system at a well site. For example, set points for addition rates of crosslinker and high-temperature stabilizer may be specified to a control component (or control system) in the hydraulic fracturing system. Lastly, it should be understood that any number of additional executable code components not shown in in FIG. 9 may be included within the tangible non-transitory computer-readable medium 900 depending on the application.

An embodiment is a hydraulic fracturing system including a pump to inject a frac fluid through a wellbore into a geological formation to hydraulically fracture the geological formation. The frac fluid has a crosslinker and a high temperature stabilizer. The hydraulic fracturing system has a hydraulic fracture model to receive a value of viscosity of the frac fluid and output a DFN correlative with the value of the viscosity. The value of viscosity is correlative with crosslinker concentration in the frac fluid and high-temperature stabilizer concentration in the frac fluid. The hydraulic fracturing system has a geomechanical model and a reservoir model coupled to give a value for hydrocarbon production correlative with the DFN. The hydraulic fracturing system has an economic calculator to determine financial gain correlative with the crosslinker concentration, the stabilizer concentration, and the hydrocarbon production. The hydraulic fracturing system may have a multi-variable model that correlates the viscosity with the crosslinker concentration and the high-temperature stabilizer concentration. The hydraulic fracture model to receive the value of viscosity from the multi-variable model. The hydraulic fracturing system may have an adjuster module to vary the crosslinker concentration in the multi-variable model and the high-temperature stabilizer concentration in the multi-variable model to increase the financial gain. The adjuster module converge on a specified crosslinker concentration and a specified high-temperature stabilizer concentration. The hydraulic fracturing system may have a control system to adjust an addition rate of the crosslinker to the frac fluid in response to the specified crosslinker concentration. The control system may adjust an addition rate of the high temperature stabilizer to the frac fluid in response to the specified crosslinker specified high-temperature stabilizer concentration. The hydraulic fracturing system may have a computing system with the hydraulic fracture model, the geomechanical model, the reservoir model, the multi-variable model, the economic calculator, and the adjuster module.

A number of implementations have been described. Nevertheless, it will be understood that various modifications may be made without departing from the spirit and scope of the disclosure.

What is claimed is:

1. A method of specifying a composition for a frac fluid, comprising:
varying a crosslinker concentration in the frac fluid;
varying a high-temperature stabilizer concentration in the frac fluid;
determining viscosity of the frac fluid;
determining a discrete fracture network (DFN) correlative with the viscosity; and
determining hydrocarbon production correlative with the DFN by employing a geomechanical model and a reservoir model.

2. The method of claim 1, wherein determining the DFN comprises simulating, via a fracture model, the hydraulic fracturing of a geological formation with the frac fluid.

3. The method of claim 1, wherein employing the geomechanical model and the reservoir model comprises coupling the geomechanical model and the reservoir model.

4. The method of claim 1, comprising determining a financial gain correlative with the crosslinker concentration, the high-temperature stabilizer concentration, and the hydrocarbon production.

5. The method of claim 4, comprising iterating through the varying of the crosslinker concentration and the varying of the high-temperature stabilizer concentration to increase the financial gain.

6. The method of claim 1, wherein determining the viscosity comprises measuring the viscosity.

7. The method of claim 6, comprising building a multi-variable model between the viscosity as measured, the crosslinker concentration, and the high-temperature stabilizer concentration.

8. The method of claim 1, wherein determining the viscosity comprises determining the viscosity with a multi-variable model that correlates the viscosity with the crosslinker concentration and the stabilizer concentration.

9. The method of claim 8, wherein varying the crosslinker concentration comprises varying the crosslinker concentration in the multi-variable model, and wherein varying the high-temperature stabilizer concentration comprises varying the high-temperature stabilizer concentration in the multi-variable model.

10. The method of claim 1, wherein the crosslinker concentration comprises concentration of a crosslinker in the frac fluid, the crosslinker comprising a zirconium (Zr) crosslinker, a titanium (Ti) crosslinker, an aluminum (Al) crosslinker, or a borate crosslinker, or any combinations thereof.

11. The method of claim 1, wherein the high-temperature stabilizer concentration comprises concentration of a high temperature stabilizer in the frac fluid, the high temperature stabilizer comprising sodium thiosulfate, sorbitol, or alkylated sorbitol, or any combinations thereof.

12. A method of determining a composition for a frac fluid, comprising:
determining viscosity for the frac fluid, wherein the viscosity is affected by a crosslinker concentration for the frac fluid and a high-temperature stabilizer concentration for the frac fluid;
employing a hydraulic fracture model to simulate hydraulic fracturing of a geological formation with the frac fluid, wherein an output of the hydraulic fracture model is a discrete fracture network (DFN);
employing a geomechanical model and a reservoir model to give hydrocarbon production from the geological formation based on the DFN;
determining a financial gain correlative with the crosslinker concentration, the high-temperature stabilizer concentration, and the hydrocarbon production; and
adjusting the crosslinker concentration for the frac fluid and the high-temperature stabilizer concentration for the frac fluid to increase the financial gain.

13. The method of claim 12, comprising specifying a selected crosslinker concentration for the frac fluid and a selected high-temperature stabilizer concentration for the frac fluid based on the financial gain.

14. The method of claim 12, wherein the crosslinker concentration comprises a concentration of a crosslinker for the frac fluid in a range of 1 gallon per thousand gallons (gpt) to 10 gpt, and wherein the high-temperature stabilizer concentration comprises a concentration of a high temperature stabilizer for the frac fluid in a range of 1 gpt to 10 gpt.

15. The method of claim 12, wherein determining the viscosity comprises determining the viscosity via a multi-variable model between the viscosity, the crosslinker concentration, and the high-temperature stabilizer concentration.

16. The method of claim 15, comprising receiving a value of the viscosity as determined into the hydraulic fracture model, wherein simulating the hydraulic fracturing with the frac fluid incorporates the value of viscosity.

17. A method of determining a composition for a frac fluid, comprising:
specifying a crosslinker concentration in the frac fluid and a stabilizer concentration in the frac fluid;
determining viscosity of the frac fluid comprising the crosslinker concentration as specified and the stabilizer concentration as specified;
simulating, via a hydraulic fracture model, hydraulic fracturing of a geological formation with the frac fluid comprising the viscosity, the crosslinker concentration as specified, and the stabilizer concentration as specified, wherein an output of the simulating is a discrete fracture network (DFN) correlative with the viscosity;
coupling performing a geomechanical model with performing a reservoir model to predict hydrocarbon production from the geological formation based on the DFN;
determining a financial gain correlative with the crosslinker concentration, the stabilizer concentration, and the hydrocarbon production; and
adjusting the specifying of the crosslinker concentration and the stabilizer concentration to increase the financial gain.

18. The method of claim 17, comprising selecting the crosslinker concentration and the stabilizer concentration based on the financial gain.

19. A computing system to specify crosslinker concentration and stabilizer concentration in a frac fluid for hydraulic fracturing, comprising:
a hydraulic fracture model to receive a value of viscosity of a frac fluid and output a discrete fracture network (DFN) correlative with the value of the viscosity, wherein the frac fluid comprises a crosslinker concentration and a stabilizer concentration;
a geomechanical model;
a reservoir model, wherein the geomechanical model and the reservoir model are coupled to give a hydrocarbon production correlative with the DFN; and
an economic calculator to determine financial gain correlative with the crosslinker concentration, the stabilizer concentration, and the hydrocarbon production.

20. The computing system of claim 19, comprising an adjuster to vary the stabilizer concentration and the stabilizer concentration to change the value of the viscosity to increase the financial gain.

21. The computing system of claim 19, wherein the crosslinker concentration is in a range of 1 gallon per thousand gallons (gpt) to 10 gpt, and wherein the stabilizer concentration is a high-temperature stabilizer concentration in a range of 1 gpt to 10 gpt.

22. The computing system of claim 19, wherein the hydraulic fracture model to receive the value of viscosity as a user input.

23. The computing system of claim 19, comprising a multi-variable model that correlates the viscosity with the crosslinker concentration and the stabilizer concentration, wherein the hydraulic fracture model to receive the value of viscosity from the multi-variable model.

24. A computing system for hydraulic fracturing, comprising:
a multi-variable model that correlates viscosity of a frac fluid with a crosslinker concentration of the frac fluid and a high-temperature stabilizer concentration of the frac fluid;
a hydraulic fracture model to simulate hydraulic fracturing of a geological formation with the frac fluid, the hydraulic fracture model to receive a viscosity value of the viscosity from the multi-variable model and output a discrete fracture network (DFN) correlative with the viscosity;
a geomechanical model and a reservoir model coupled to give an amount of hydrocarbon production correlative with the DFN; and
an adjuster to change the crosslinker concentration in the multi-variable model and the stabilizer concentration in the multi-variable model.

25. The computing system of claim 24, comprising an economic calculator to determine financial gain correlative with the crosslinker concentration, the high-temperature stabilizer concentration, and the hydrocarbon production.

26. The computing system of claim 24, wherein the adjuster to change the crosslinker concentration and the high-temperature stabilizer concentration in response to at least the amount of hydrocarbon production.

27. A hydraulic fracturing system comprising:
a pump to inject a frac fluid through a wellbore into a geological formation to hydraulically fracture the geological formation, wherein the frac fluid comprises a crosslinker and a high temperature stabilizer;
a hydraulic fracture model to receive a value of viscosity of the frac fluid and output a discrete fracture network (DFN) correlative with the value of the viscosity, wherein the value of viscosity is correlative with crosslinker concentration in the frac fluid of the crosslinker and with high-temperature stabilizer concentration of the high temperature stabilizer in the frac fluid;
a geomechanical model and a reservoir model coupled to give a value for hydrocarbon production correlative with the DFN; and
an economic calculator to determine financial gain correlative with the crosslinker concentration, the stabilizer concentration, and the hydrocarbon production.

28. The hydraulic fracturing system of claim 27, comprising a multi-variable model that correlates the viscosity with the crosslinker concentration and the high-temperature stabilizer concentration, wherein the hydraulic fracture model to receive the value of viscosity from the multi-variable model.

29. The hydraulic fracturing system of claim 28, comprising an adjuster to vary the crosslinker concentration in the multi-variable model and the high-temperature stabilizer concentration in the multi-variable model to increase the financial gain, wherein the adjuster to converge on a specified crosslinker concentration and a specified high-temperature stabilizer concentration.

30. The hydraulic fracturing system of claim 29, comprising a control system to adjust an addition rate of the crosslinker to the frac fluid and an addition rate of the high temperature stabilizer to the frac fluid in response to the specified crosslinker concentration and the specified high-temperature stabilizer concentration, respectively.

31. The hydraulic fracturing system of claim 29, comprising a computing system comprising the hydraulic fracture model, the geomechanical model, the reservoir model, the multi-variable model, the economic calculator, and the adjuster.
